(19) United States
(12) Patent Application Publication
(10) Pub. No.: US 2023/0059441 A1
(43) Pub. Date: Feb. 23, 2023

(54) MAGNETIC FLUID DRIVE DEVICE AND HEAT TRANSPORT SYSTEM

(71) Applicant: Panasonic Intellectual Property Management Co., Ltd., Osaka (JP)

(72) Inventor: Tsutomu YOSHIKAWA, Nara (JP)

(21) Appl. No.: 17/981,718

(22) Filed: Nov. 7, 2022

Related U.S. Application Data
(63) Continuation of application No. PCT/JP2021/010121, filed on Mar. 12, 2021.

(30) Foreign Application Priority Data
May 19, 2020 (JP) 2020-087421

(51) Int. Cl. F25B 21/02

(52) U.S. Cl. CPC F25B 21/02; F25B 2321/0022

(57) ABSTRACT

A magnetic fluid drive device for driving a magnetic fluid having temperature sensitivity in accordance with heat reception, the magnetic fluid drive device includes: a heat receiver having a flow channel through which the magnetic fluid flows, to receive heat; a magnet member disposed outside the flow channel to generate a magnetic field; and a drive mechanism that changes a position of the magnet member with respect to the heat receiver from a first position that is adjacent to the heat receiver with the magnet member applying the magnetic field to the magnetic fluid in the flow channel.

### BACKGROUND

### 1. Technical Field

The present disclosure relates to a magnetic fluid drive device and a heat transport system including the magnetic fluid drive device.

### 2. Related Art

JP 2014-50140 A discloses a magnetic fluid drive device for use in a system that moves a heated magnetic fluid to use thermal energy or kinetic energy thereof. The magnetic fluid drive device of JP 2014-50140 A includes a circulation flow channel in which a magnetic fluid is sealed, and a heating part and a magnetic field applying part provided in the circulation flow channel. An inner diameter of a cross section of the circulation flow channel is reduced to achieve downsizing of the device. As an example of application of this magnetic fluid drive device, there is disclosed a heat transfer device using a heat pipe or the like provided with a magnetic field applying part and a heat generation part.

JP 2018-59484 A discloses a magnetic fluid drive device as means for efficiently driving a magnetic fluid to transfer heat using a heat medium flowing in a tube as a heat source. The magnetic fluid drive device of JP 2018-59484 A includes a double tube having an inner tube and an outer tube formed outside the inner tube, and a magnetic field applying part disposed outside the double tube. In JP 2018-59484 A, a magnetic fluid is driven by circulating a heat medium in the inner tube.

### SUMMARY

The present disclosure provides a magnetic fluid drive device and a heat transport system that enable improvement in driving efficiency of a magnetic fluid drive device for driving a magnetic fluid according to heat reception.

A magnetic fluid drive device according to the present disclosure drives a magnetic fluid having temperature sensitivity according to heat reception. The magnetic fluid drive device includes a heat receiver, a magnet member, and a drive mechanism. The heat receiver has a flow channel through which a magnetic fluid flows, to receive heat. The magnet member is disposed outside the flow channel to generate a magnetic field. The drive mechanism changes a position of the magnet member with respect to the heat receiver from a first position that is adjacent to the heat receiver with the magnet member applying the magnetic field to the magnetic fluid in the flow channel.

A heat transport system according to the present disclosure includes the above-described magnetic fluid drive device and a radiator that is coupled to the magnetic fluid drive device, to dissipate heat from the magnetic fluid.

According to the magnetic fluid drive device and the heat transport system in the present disclosure, it is possible to improve driving efficiency of the magnetic fluid drive device for driving the magnetic fluid according to the heat reception.

### BRIEF DESCRIPTION OF THE DRAWINGS

FIG. 1 is a view illustrating a configuration of a heat transport system according to a first embodiment of the present disclosure;

FIG. 2 is a perspective view illustrating a configuration example of a magnetic fluid drive device in the heat transport system of the first embodiment;

FIG. 3 is a front view of the magnetic fluid drive device of FIG. 2;

FIG. 4 is a side view of the magnetic fluid drive device of FIG. 2;

FIG. 5 is a view for explaining an operation principle of the magnetic fluid drive device in the heat transport system;

FIGS. 6A and 6B are views for explaining sticking and peeling of a magnetic fluid in the magnetic fluid drive device;

FIG. 7 is a view for explaining stirring of the magnetic fluid by driving by a magnet in the magnetic fluid drive device;

FIG. 8 is a front view illustrating a configuration example of a magnetic fluid drive device according to a second embodiment;

FIG. 9 is a cross-sectional view of the magnetic fluid drive device of FIG. 8;

FIGS. 10A and 10B are views for explaining action of a magnetic component in the magnetic fluid drive device of the second embodiment;

FIG. 11 is a front view of a magnetic fluid drive device according to a first modification of the second embodiment;

FIG. 12 is a front view of a magnetic fluid drive device according to a second modification of the second embodiment;

FIG. 13 is a cross-sectional view of the magnetic fluid drive device of FIG. 12;

FIG. 14 is a front view of a magnetic fluid drive device according to a third modification of the second embodiment;

FIG. 15 is a cross-sectional view of a magnetic fluid drive device according to a fourth modification of the second embodiment;

FIG. 16 is a perspective view illustrating a configuration example of a magnetic fluid drive device according to a third embodiment;

FIG. 17 is a front view of the magnetic fluid drive device of FIG. 16;

FIG. 18 is a view for explaining operation of the magnetic fluid drive device of the third embodiment;

FIGS. 19A and 19B are views for explaining a configuration example of a magnetic fluid drive device according to a fourth embodiment;

FIGS. 20A and 20B are views for explaining a magnetic fluid drive device according to a first modification of the fourth embodiment;

FIG. 21 is a perspective view illustrating a configuration of a magnetic fluid drive device according to a second modification of the fourth embodiment;

FIG. 22 is a view for explaining a magnetic fluid drive device according to a third modification of the fourth embodiment;

FIG. 23 is a flowchart illustrating control of the magnetic fluid drive device according to the third modification of the fourth embodiment;

FIG. 24 is a perspective view illustrating a configuration of a magnetic fluid drive device according to a first modification of the first embodiment; and

FIG. 25 is a perspective view illustrating a configuration of a magnetic fluid drive device according to a second modification of the first embodiment.

### DESCRIPTION OF EMBODIMENTS

In the following, embodiments will be described in detail with reference to the drawings as appropriate. Note that unnecessarily detailed description may be omitted. For example, detailed description of a well-known matter and repeated description of substantially the same configuration may be omitted. This is to prevent the following description from being unnecessarily redundant and to facilitate understanding of those skilled in the art.

Note that the applicant provides the accompanying drawings and the following description in order for those skilled in the art to fully understand the present disclosure, and does not intend to limit the subject matter described in the claims.

The inventor of the present application has newly found a unique problem in realizing a magnetic fluid drive device and a heat transport system, and has reached the present disclosure through intensive studies to solve the problem.

### First Embodiment

A first embodiment of the present disclosure will be described below with reference to the drawings.

### 1. Configuration

### 1-1. Heat Transport System

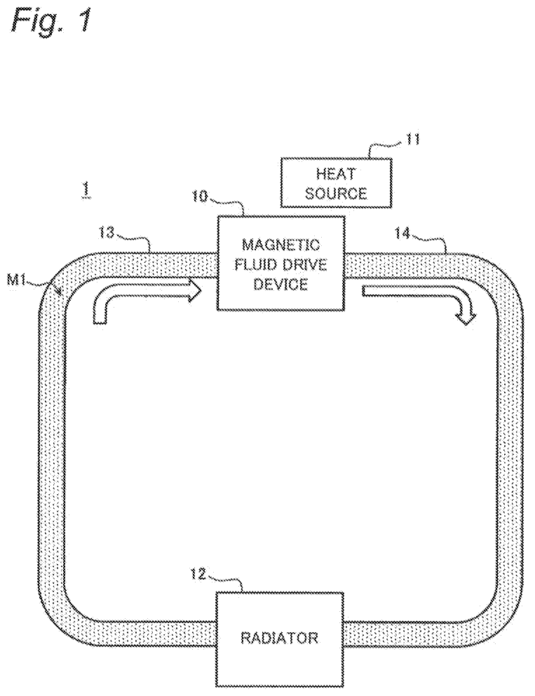

A heat transport system according to a first embodiment will be described with reference to FIG. 1.

FIG. 1 illustrates a configuration of a heat transport system 1 according to the present embodiment. The heat transport system 1 includes a magnetic fluid drive device 10 disposed in the vicinity of a heat source 11, a radiator 12, and flow channel tubes 13 and 14 coupling the magnetic fluid drive device 10 with the radiator 12. For example, the heat transport system 1 of the present embodiment is incorporated in various electronic apparatuses, to transfer heat such that the magnetic fluid drive device 10 works as a cooling mechanism that cools the heat source 11 generating heat in components of the apparatus. The present system 1 may include the heat source 11.

A magnetic fluid M1, which has temperature sensitivity that is temperature dependency of magnetization, is sealed in the flow channel tubes 13 and 14 and the like of the present system 1. The magnetic fluid drive device 10 is a device for driving the magnetic fluid M1 in a self-excited manner according to heat received from the outside such as from the heat source 11, by using a temperature change of a magnetic body force acting on the magnetic fluid M1. The magnetic fluid drive device 10 of the present embodiment includes a drive mechanism capable of suppressing a specific situation in which the magnetic fluid drive device 10 is to be hard to work well in the heat transport system 1. Details of the magnetic fluid drive device 10 will be described later.

In the present system 1, the flow channel tubes 13 and 14 constitute a flow channel of a part for circulating the magnetic fluid M1 between the magnetic fluid drive device 10 and the radiator 12. The magnetic fluid M1 contains ferromagnetic particles and a mother liquid in which the ferromagnetic particles are dispersed. For example, the ferromagnetic particles may be iron oxide-based fine particles, spinel ferrite, or the like. As the mother liquid of the magnetic fluid M1, water or a hydrocarbon-based liquid such as kerosene can be used. The magnetic fluid M1 may be a colloid or may be configured using a microcapsule technology (see Ryota Aizawa et al., “Synthesis of Thermosensitive Magnetic Fluid Microcapsules and Flow Field Visualization”, No. 18-29, Proceedings of the Thermal Engineering Conference 2018 of the Japan Society of Mechanical Engineers, October 2018). The temperature sensitivity of the magnetic fluid M1 is appropriately set in consideration of a temperature presumed from heat generation of the heat source 11 and a Curie temperature.

The radiator 12 dissipates heat from the high-temperature magnetic fluid M1 flowing therein from the heat receiver 21 via the flow channel tube 14. The radiator 12 is connected to the flow channel tube 13 so as to circulate the heat dissipated magnetic fluid M1 again to the heat receiver 21. The radiator 12 can be configured by various heat sinks. The radiator 12 may be a radiator using a Peltier element. The magnetic fluid drive device 10 may be provided separately from the radiator 12.

In an exemplary case where the electronic apparatus is a projector, the heat source 11 of the present system 1 is a light source element such as a semiconductor laser or an LED array, a spatial light modulation element such as a DMD, a phosphor element, an optical system, or the like. Furthermore, not only the projector but also a semiconductor element such as a CPU or an LSI in various apparatuses, a secondary battery, and the like are examples of the heat source 11.

### 1-2. Magnetic Fluid Drive Device

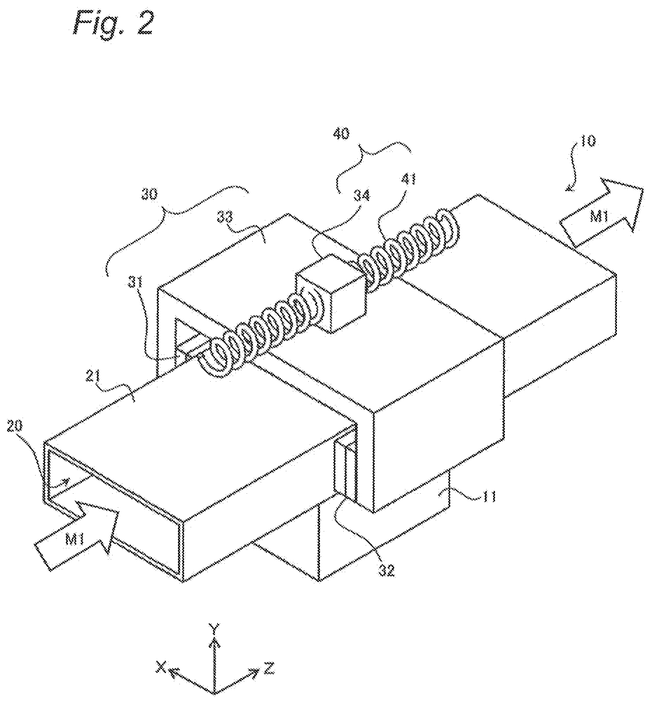

The structure of the magnetic fluid drive device 10 according to the first embodiment will be described in detail with reference to FIGS. 2 to 4.

FIG. 2 is a perspective view illustrating configuration example of the magnetic fluid drive device 10 in the heat transport system 1 of the present embodiment. As shown in FIG. 2, the magnetic fluid drive device 10 of the present configuration example includes the heat receiver 21 having a flow channel 20, magnets 31 and 32 and a magnetic yoke 33 constituting a magnet member 30, and a drive spring 41 constituting a drive mechanism of the magnet member 30.

The heat receiver 21 is a tubular member forming the flow channel 20 of a portion where the magnetic fluid M1 receives heat from the heat source 11 in the magnetic fluid drive device 10, and includes a connection portion (not illustrated) connected to the flow channel tubes 13 and 14 in FIG. 1, for example. FIG. 2 illustrates a state in which the flow channel 20 is opened in the heat receiver 21 (the same applies hereinafter).

In the magnetic fluid drive device 10 of the configuration example shown in FIG. 2, the flow channel 20 of the heat receiver 21 has a rectangular cross-sectional shape. Hereinafter, a flow channel direction in which the flow channel 20 of the heat receiver 21 extends is defined as a Z direction, a width direction of the rectangle orthogonal to the Z direction is defined as an X direction, and a height direction of the rectangle orthogonal to the Z and X directions is defined as a Y direction. Hereinafter, a +Y side may be referred to as an upper side, and a −Y side may be referred to as a lower side.

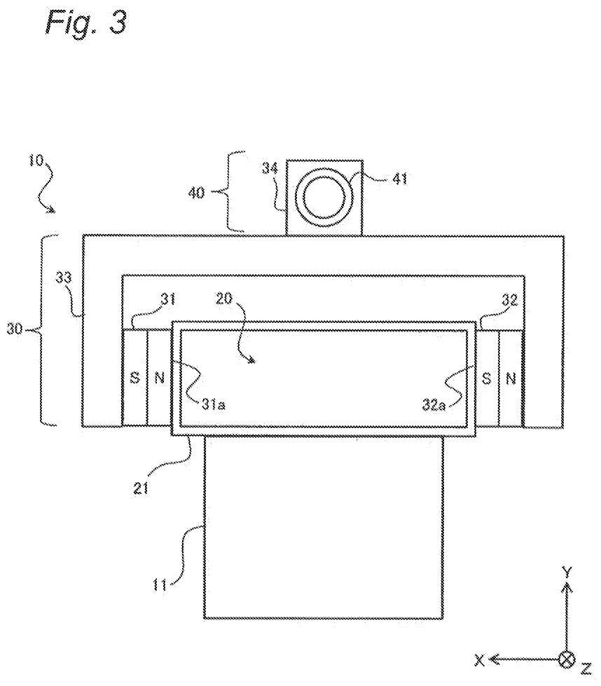

FIG. 3 is a front view of the magnetic fluid drive device 10 of FIG. 2 as viewed from a −Z side. In the present configuration example, the two magnets 31 and 32 of the magnetic fluid drive device 10 are disposed adjacent to both ends (i.e., ±X side) of the heat receiver 21 so as to face to each other in the X direction via the heat receiver 21. For example, the two magnets 31 and 32 have the same dimensions. For example, each of the magnets 31 and 32 is formed in a flat plate shape and has two principal surfaces. The principal surfaces of each of the magnets 31 and 32 are disposed along side surfaces of the heat receiver 21 parallel to the Y and Z directions, for example. The magnets 31 and 32 are permanent magnets such as a neodymium magnet, a ferrite magnet, or a samarium cobalt magnet.

FIG. 3 illustrates polarities of magnetic poles of the magnets 31 and 32 in the magnetic fluid drive device 10. For example, each principal surface of the magnets 31 and 32 constitutes an N pole or an S pole. A principal surface 31a of one magnet 31 adjacent to the heat receiver 21 and a principal surface 32a of the other magnet 32 adjacent to the heat receiver 21 have opposite polarities. Such opposed principal surfaces 31a and 32a of the two magnets 31 and 32 show an example of a pair of opposed surfaces in the present embodiment.

For example, the magnetic yoke 33 is formed in a U shape and is coupled to the two magnets 31 and 32 over the +Y side (i.e., upward) of the heat receiver 21. A magnetic circuit having the magnets 31 and 32 and the magnetic yoke 33 coupled magnetically is capable of enhancing a magnetic field to be applied to the heat receiver 21. The magnets 31 and 32 and the magnetic yoke 33 constitute the magnet member 30 that generates a magnetic field for driving the magnetic fluid M1 in the magnetic fluid drive device 10 of the present embodiment. The magnetic yoke 33 is provided, on an upper side thereof, with a coupling part 34 that is a part coupled to the drive spring 41, for example.

The drive spring 41 includes various spring members, and is provided to extend and contract along the Z direction from the coupling part 34 of the magnetic yoke 33. For example, as illustrated in FIG. 2, the drive spring 41 may be provided on both sides on ±Z sides, or may be provided on one side on the ±Z side. The drive spring 41 is a drive mechanism 40 that drives the magnet member 30 together with the coupling part 34 in the magnetic fluid drive device 10 of the present embodiment.

For example, the heat source 11 of the heat transport system 1 has a heat generation surface that generates heat in a planar manner. The heat generation surface may have various ups and downs according to shape, structure, arrangement, and the like of various components of the heat source 11. The heat source 11 is disposed adjacent to a lower side (−Y side) of the heat receiver 21 with the heat generation surface facing upward (+Y side), for example. By having a large area where the heat generation surface and the heat receiver 21 are close to each other, heat transfer from the heat source 11 to the heat receiver 21 can be efficiently performed.

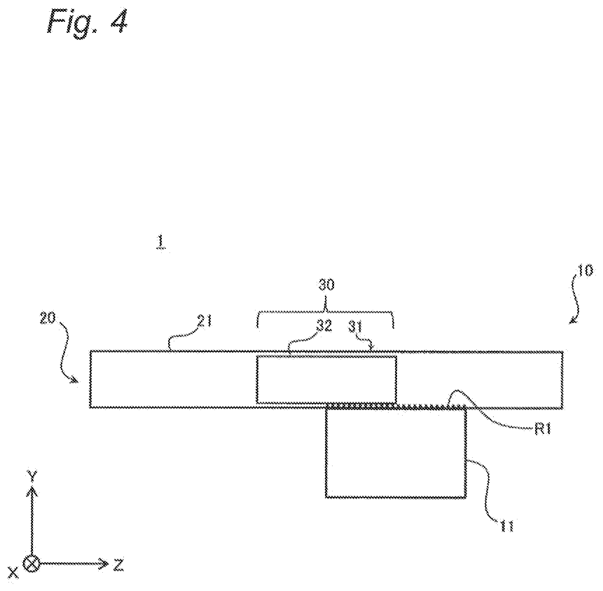

FIG. 4 is a side view of the magnetic fluid drive device 10 of FIG. 2 as viewed from a −X side. In FIG. 4, illustration of the magnetic yoke 33 and the drive spring 41 is omitted. Basically, the magnets 31 and 32 and the heat source 11 are arranged such that their positions in the Z direction, in which the magnetic fluid M1 flows, are deviated from each other. In other words, as shown in FIG. 4, the basic position of the magnet member 30 in the magnetic fluid drive device 10 is a position where the magnets 31 and 32 constituting the magnetic poles overlap at an end portion of a heat reception region R1 in the Z direction of the flow channel 20. The heat reception region R1 is a region where the heat receiver 21 faces the heat generation surface of the heat source 11 to mainly receive heat.

For example, the basic position of the magnet member 30 as illustrated in FIG. 4 has, in the Z direction, a range in which the heat generation surface of the heat source 11 corresponding to the heat reception region R1 is disposed so as to overlap approximately half of the range in which the magnets 31 and 32 are disposed on the +Z side. For example, the range of the heat generation surface is also allowed to extend to the +Z side from the range of the magnets 31 and 32. The range of such arrangement is appropriately set according to various conditions from a viewpoint of enhancing a driving force of the magnetic fluid M1. The magnetic fluid drive device 10 of the present configuration example, can make it easy to finely adjust the arrangement of the heat source 11 and the magnets 31 and 32 without considering mutual interference.

In the magnetic fluid drive device 10 of the present embodiment, the drive mechanism 40 shifts the magnet member 30 in the Z direction of the flow channel 20 from the basic position as described above, and a relative positional relation between the magnet member 30 and the heat receiver 21 changes. The drive mechanism 40 of the configuration example shown in FIG. 2 can be driven according to external vibration, such as vibration of various apparatuses in which the heat transport system 1 is incorporated. A movable range, in which the drive mechanism 40 is able to drive the magnet member 30 in the Z direction, can be appropriately set in consideration of a position where both the heat reception region R1 and the magnets 31 and 32 overlap each other as a whole or a position where both do not overlap each other as a whole, for example.

### 2. Operation

Operations of the heat transport system 1 and the magnetic fluid drive device 10 configured as described above will be described below.

### 2-1. Operation Principle

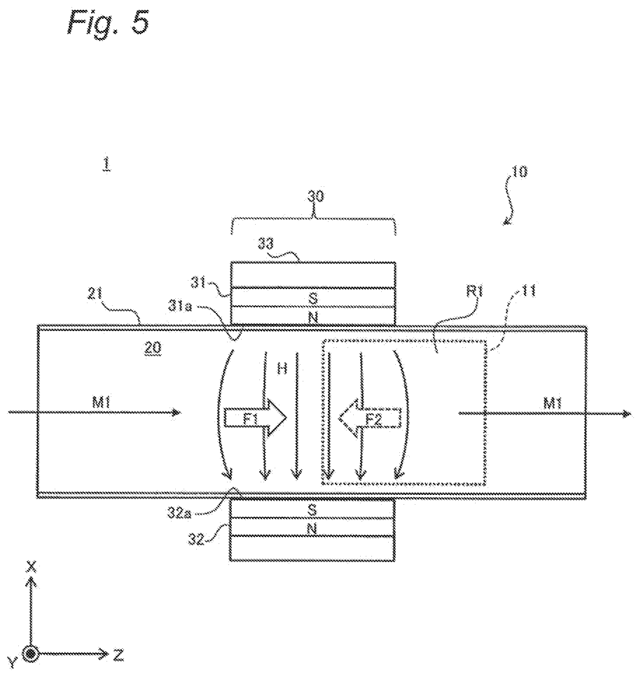

FIG. 5 is a view for explaining an operation principle of the magnetic fluid drive device 10 in the heat transport system 1. FIG. 5 corresponds to the cross-sectional view of an XZ cross section of the magnetic fluid drive device 10 taken along the flow channel 20 in the configuration example shown in FIG. 2, with the magnet member 30 being at the basic position (see FIG. 4).

In the magnetic fluid drive device 10 of the heat transport system 1, as illustrated in FIG. 5, a magnetic field H from the two magnets 31 and 32 is applied to the magnetic fluid M1 in the heat receiver 21, for example. As a result, a magnetic body force proportional to a gradient of the magnetic field H as well as to magnetization of the magnetic fluid M1 acts on the magnetic fluid M1 (see JP 2014-50140 A and JP 2018-59484 A). FIG. 5 illustrates a magnetic body force F1 on the −Z side and a magnetic body force F2 on the +Z side. For example, in a case where the heat source 11 does not generate heat and thus a temperature of the magnetic fluid M1 does not change between the +Z side and the −Z side, the magnetic body forces F1 and F2 are balanced, so that the magnetic fluid M1 does not particularly move.

When the heat source 11 generates heat, the magnetic fluid M1 receives the heat from the heat source 11 on the +Z side of the heat receiver 21. As a result, the temperature of the magnetic fluid M1 on the +Z side rises to be higher than that on the −Z side. According to the temperature sensitivity of the magnetic fluid M1, the magnetization of the magnetic fluid M1 becomes weak as the temperature increases. Therefore, the magnetic body force F2 on the +Z side is weakened, and the magnetic body forces F1 and F2 on the ±Z side loose balance. Then, the magnetic body force F1 on the −Z side is dominant as the entire force acting on the magnetic fluid M1, and the magnetic fluid M1 is driven to flow from the −Z side to the +Z side.

The magnetic fluid M1, receiving heat on the +Z side of the heat receiver 21 to obtain a high temperature, flows out from the +Z side of the heat receiver 21, and further travels through the flow channel tube 14, to reach the radiator 12 (see FIG. 1). The radiator 12 dissipates heat of the magnetic fluid M1. As a result, the magnetic fluid M1 passing through the radiator 12 can flow into the heat receiver 21 again from the −z side with the temperature being lower than that at the time of outflow from the heat receiver 21. Such circulation is continued as long as the heat receiver 21 has a temperature gradient due to heat generation of the heat source 11. For example, when the heat generated by the heat source 11 is constant, a thermally balanced state is obtained, and a flow rate of the magnetic fluid M1 is kept constant. When the heat generation of the heat source 11 stops, the flow rate of the magnetic fluid M1 gradually decreases and eventually stops.

As described above, the heat transport system 1 of the present embodiment can cool the heat source 11 by transferring heat by a function driving the magnetic fluid M1 in a self-circulating manner by the magnetic fluid drive device 10. The circulation function of the magnetic fluid M1 obtained by the magnetic fluid drive device 10 is realized in a self-excited manner of spontaneously operating when the heat source 11 generates heat and stopping when the heat source 11 is cooled.

### 2-2. Problems of Magnetic Fluid Drive Device

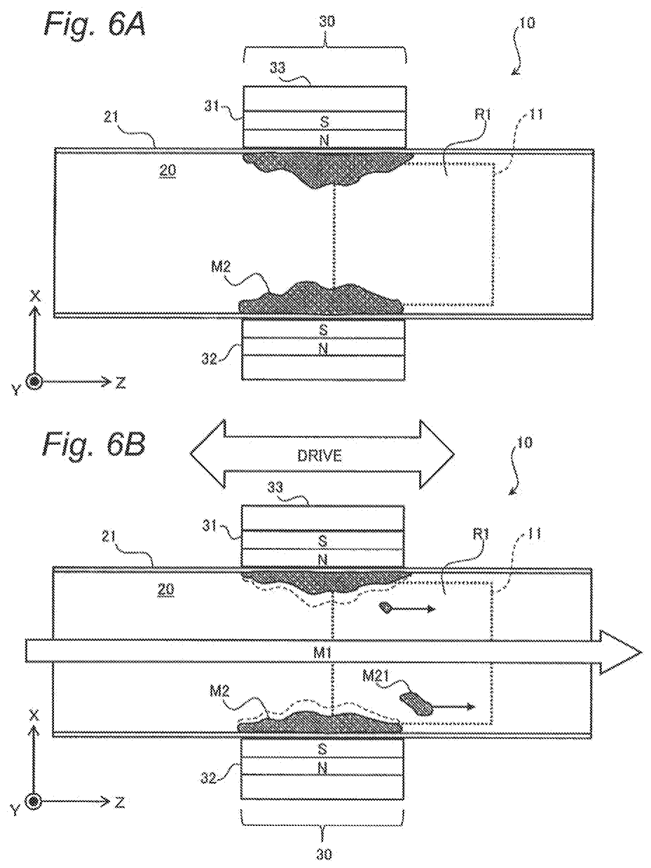

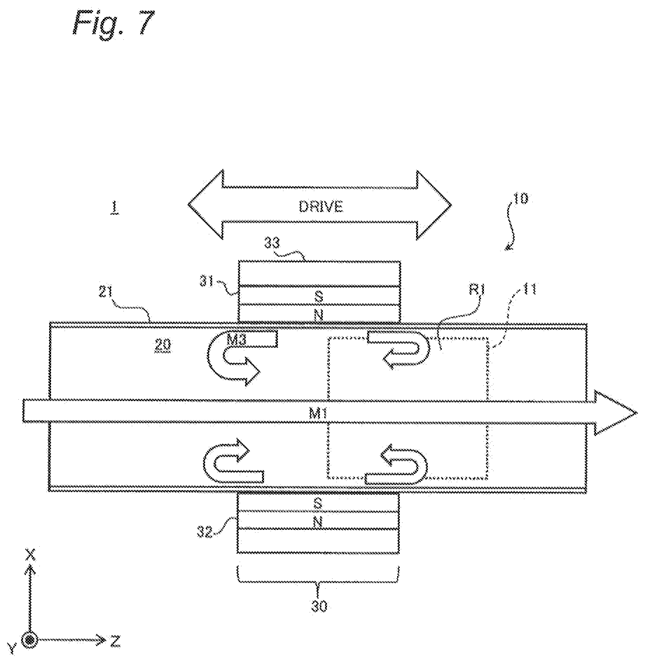

With reference to FIGS. 6A to 7, description will be made of specific problems that the magnetic fluid drive device 10 has difficulty in functioning when the heat transport system 1 based on the magnetic fluid drive device 10 as described above is operated, and solutions thereof.

FIGS. 6A and 6B are views for explaining sticking and peeling of the magnetic fluid M1 in the magnetic fluid drive device 10. FIG. 7 is a view for explaining stirring of the magnetic fluid by driving a magnet in the magnetic fluid drive device 10.

FIG. 6A illustrates a state in which a sticking substance M2 occurs in the flow channel 20 of the magnetic fluid drive device 10. The sticking substance M2 is formed by a densely gelling particle group of colloidal particles in the magnetic fluid M1, for example. For example, during a period in which the heat source 11 does not particularly generate heat in the heat transport system 1, the circulation function of the magnetic fluid M1 obtained by the magnetic fluid drive device 10 is not particularly activated. Then, when the state in which the magnetic fluid M1 is not driven in the magnetic fluid drive device 10 continues for a long period of time, the particle groups in the magnetic fluid M1 may gather in the vicinity of the magnets 31 and 32 on an inner wall of the flow channel 20, resulting in sticking the particles to the inner wall of the flow channel 20 as a sticking substance M2, as shown in FIG. 6A.

The sticking substance M2 peculiar to the magnetic fluid drive device 10 as described above would hinder heat transfer from a wall surface of the flow channel 20 to the magnetic fluid M1, at the heat generation of the heat source 11, for example. Furthermore, the flow channel 20 would be blocked by a growth of the sticking substance M2. There is a problem of difficulty in efficiently driving the magnetic fluid drive device 10 in order to cool the heat source 11.

In the present embodiment, the magnetic fluid drive device 10 can enable suppression of such influence of the sticking substance M2 as described above, by using the simple drive mechanism 40 as in the configuration example shown in FIG. 2, for example. This topic will be described with reference to FIG. 6B.

FIG. 6B illustrates a case where the drive mechanism 40 in the magnetic fluid drive device 10 of the present embodiment is driven from the state shown in FIG. 6A. The drive mechanism 40 of the magnetic fluid drive device 10 of the present embodiment shifts the magnet member 30 along the Z direction of the flow channel 20 so that the positions of the magnets 31 and 32 with respect to the heat receiver 21 change. According to this, the sticking substance M2 can be peeled off by applying a force generated by a change of the magnetic field which the magnets 31 and 32 causes in the flow channel 20. For example, the magnetic fluid M1 in the flow channel 20 is stirred in conjunction with movement of the driven magnets 31 and 32, thereby peeling off the sticking substance M2.

A method and timing for driving the drive mechanism 40 of the magnetic fluid drive device 10 are not particularly limited, and the drive mechanism can be driven at any time in various driving methods. For example, a particle group M21, which has been peeled off when the circulation function of the magnetic fluid M1 is activated by the magnetic fluid drive device 10, has magnetization reduced by heating from the heat source 11 that generates heat. This enables the peeled particle group M21 to flow away together with the magnetic fluid M1 without being captured by the magnetic fields of the magnets 31 and 32.

As described above, the magnetic fluid drive device 10 of the present embodiment enables the sticking substance M2 to be peeled off by the drive mechanism 40 that shifts the magnet member 30. Therefore, it is possible to suppress the hindering influence to the function of the magnetic fluid drive device 10 by the sticking substance M20, and to efficiently drive the magnetic fluid drive device 10.

When the heat source 11 is cooled by the magnetic fluid drive device 10 in the heat transport system 1 of the present embodiment, there may occur a problem that a heat transfer rate decreases from a viewpoint different from the above. Specifically, during the operation of the circulation function of the magnetic fluid M1 by the magnetic fluid drive device 10, it might be difficult to efficiently cool the heat source 11 due to formation of a laminar flow in the vicinity of the heat reception region R1 where heat is exchanged with the heat source 11 in the flow channel 20, or due to shortage of the flow rate of the magnetic fluid M1.

In the present embodiment, the magnetic fluid drive device 10 can also solve the above-described problem peculiar to the heat transport system 1, by using the drive mechanism 40. This topic will be described with reference to FIG. 7.

FIG. 7 illustrates a state in which the circulation function of the magnetic fluid M1 activated by the magnetic fluid drive device 10 is in operation in the present system 1. In the example of FIG. 7, when the magnetic fluid drive device 10 is cyclically driving the magnetic fluid M1 according to the heat generation of the heat source 11, the drive mechanism 40 shift-drives the magnet member 30. At this time, as the magnetic fluid M1 acts in conjunction with the magnetic field from the magnet member 30, a turbulence M3 of the magnetic fluid M1 may occur in the flow channel 20. Such turbulence M3 enables improvement in the heat transfer rate in the heat transfer in the flow channel 20 in the magnetic fluid drive device 10 as compared with a case with only a laminar flow.

### 3. Conclusion

As described above, in the present embodiment, the magnetic fluid drive device 10 drives the magnetic fluid M1 having temperature sensitivity according to heat reception. The magnetic fluid drive device 10 includes the heat receiver 21, the magnet member 30, and the drive mechanism 40. The heat receiver 21 has the flow channel 20 through which the magnetic fluid M1 flows, to receive heat. The magnet member 30 is disposed outside the flow channel 20 to generate a magnetic field. The drive mechanism 40 changes the position of the magnet member 30 with respect to the heat receiver 21 from the basic position (a first position) adjacent to the heat receiver 21 such that the magnet member 30 applies a magnetic field to the magnetic fluid M1 in the flow channel 20.

According to the magnetic fluid drive device 10 described above, by changing the position of the magnet member 30 with respect to the heat receiver 21 using the drive mechanism 40, it is possible to improve the efficiency to drive the magnetic fluid drive device 10 for driving the magnetic fluid M1 according to heat reception.

In the present embodiment, the drive mechanism 40 changes the position of the magnet member 30 with respect to the heat receiver 21 in the Z direction which is the flow channel direction in which the flow channel 20 extends. According to such drive mechanism 40, even if the sticking substance M2 occurs in the vicinity of the magnet member 30 inside the flow channel 20 in the magnetic fluid drive device 10, the sticking substance M2 can be peeled off. In addition, the turbulence M3 of the magnetic fluid M1 can be generated in the flow channel 20 to improve the heat transfer rate.

### Second Embodiment

A second embodiment will be described below with reference to the drawings. In the first embodiment, the description has been made of the magnetic fluid drive device 10 that drives the magnet member 30 by the drive mechanism 40. In the second embodiment, description will be made of a magnetic fluid drive device including a magnetic member that operates in conjunction with driving of the magnet member 30 inside the flow channel 20.

In the following, description of configurations and operations similar to those of the heat transport system 1 and the magnetic fluid drive device 10 of the first embodiment will be appropriately omitted, and a magnetic fluid drive device according to the present embodiment will be described.

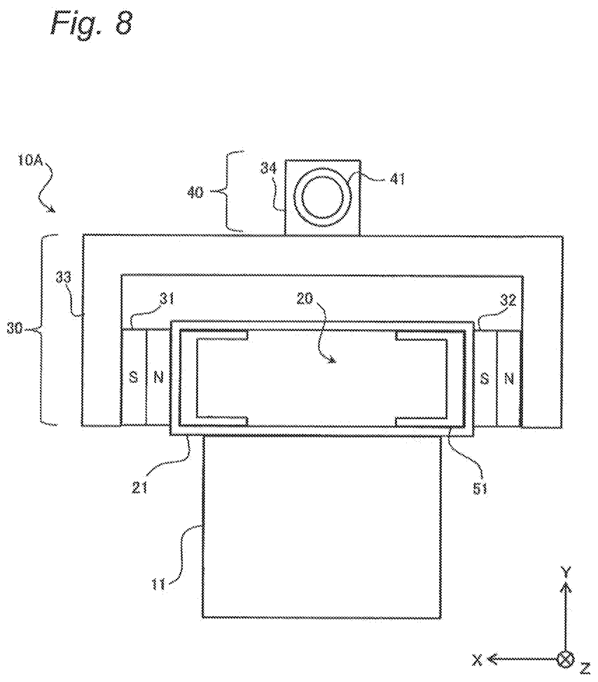

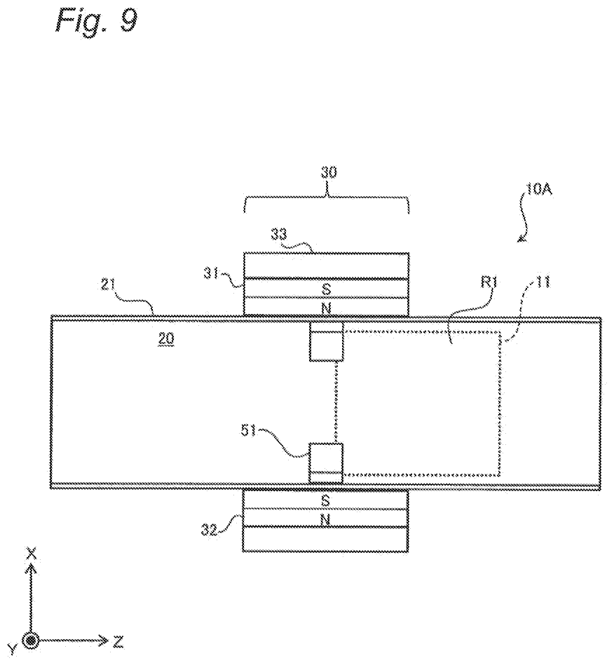

FIG. 8 is a front view showing a configuration example of a magnetic fluid drive device 10A according to the second embodiment. FIG. 9 is a cross-sectional view of the magnetic fluid drive device 10A with the XZ section in FIG. 8.

In addition to the similar configuration to the magnetic fluid drive device 10 of the first embodiment, the magnetic fluid drive device 10A of the present embodiment further includes a magnetic component 51 disposed inside the flow channel 20 of the heat receiver 21, as shown in FIGS. 8 and 9, for example. The magnetic component 51 is a slider made of a magnetic material, and is an example of a magnetic member of the present embodiment.

The magnetic component 51 in the configuration example of FIG. 8 has a height equal to or less than a height of the flow channel 20, and is formed in accordance with a shape of the flow channel 20. In the present configuration example, two magnetic components 51 are disposed in the flow channel 20. Each magnetic component 51 is positioned in the vicinity of each of the magnets 31 and 32 in the flow channel 20 according to the action of the magnetic field by the magnets 31 and 32. In the magnetic fluid drive device 10A of the present embodiment, the number of magnetic components 51 is not limited to two, and may be three or more, or may be one.

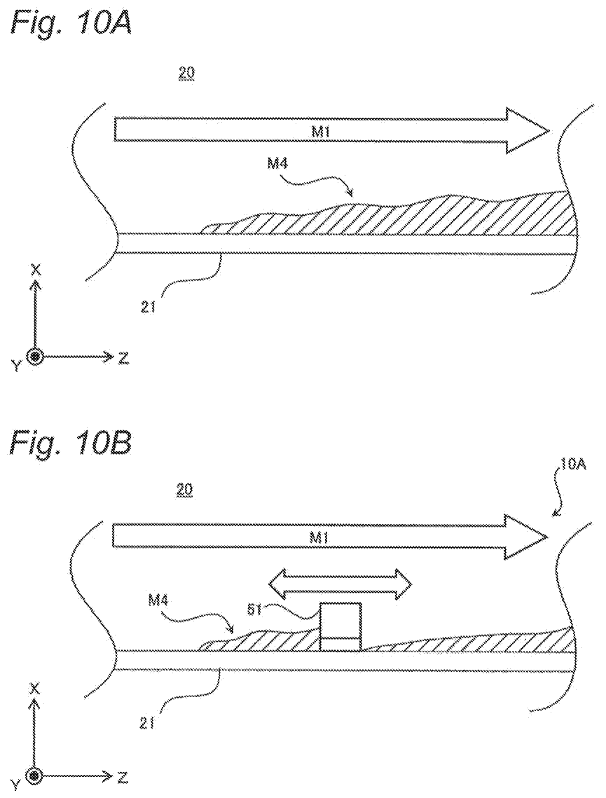

In the magnetic fluid drive device 10A of the present embodiment, when the magnet member 30 is driven by the drive mechanism 40 as in the first embodiment, the magnetic component 51 slides in the flow channel 20 following the movement of the magnets 31 and 32. According to this, the magnetic component 51 can directly peel off the sticking substance M2 (see FIGS. 6A and 6B) on the inner wall of the flow channel 20, resulting in facilitating peel-off of the sticking substance M2. Further action of the magnetic component 51 will be described with reference to FIGS. 10A and 10B.

FIG. 10A illustrates a state in the flow channel 20 in a case where the magnetic component 51 is not provided. FIG. 10B illustrates a state in the flow channel 20 in the magnetic fluid drive device 10A with the magnetic component 51 in the present embodiment. FIGS. 10A and 10B illustrate a state during cooling of the heat source 11.

For example, when heat is transferred from the heat source 11 to the magnetic fluid M1 via a tube wall of the flow channel 20 in the heat receiver 21, a temperature boundary layer M4 occurs in the magnetic fluid M1 in the flow channel 20, as shown in FIG. 10A. Then, the efficiency of heat transfer may be reduced. In contrast to this, according to the magnetic fluid drive device 10A of the present embodiment, the magnetic component 51 in the flow channel 20 moves along the inner wall of the flow channel 20, so that the temperature boundary layer M4 can be scraped off, as shown in FIG. 10B. In addition, the magnetic component 51 can easily cause a turbulence in the flow channel 20. In this manner, according to the magnetic fluid drive device 10A of the present embodiment, heat transfer efficiency can be improved.

As described above, the magnetic fluid drive device 10A of the present embodiment further includes the magnetic component 51 as an example of the magnetic member that is disposed inside the flow channel 20 in the heat receiver 21 to move according to a change in the position of the magnet member 30 in the flow channel direction. By causing the magnetic component 51 in the flow channel 20 to operate in conjunction with the driving of the magnet member 30, the heat transfer rate and the like can be improved.

### Modification of Second Embodiment

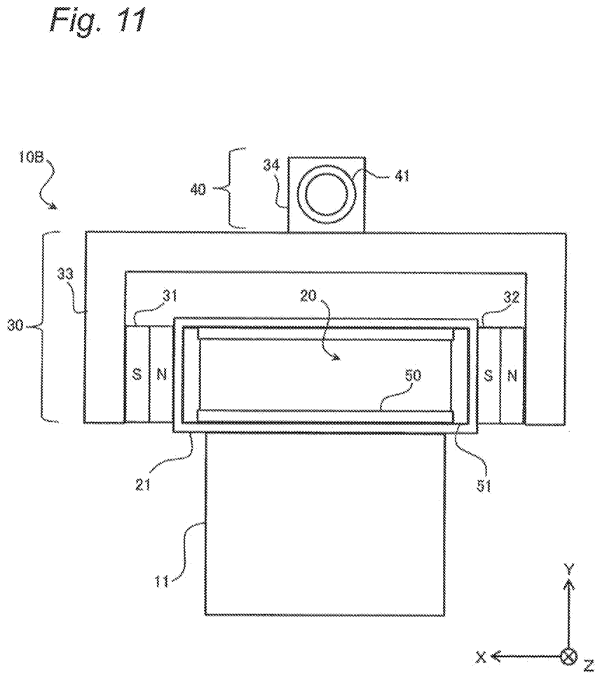

A modification of the above-described magnetic fluid drive device 10A of the second embodiment will be described with reference to FIGS. 11 to 15.

FIG. 11 is a front view of a magnetic fluid drive device 10B according to a first modification of the second embodiment. The magnetic fluid drive device 10B of the present modification further includes a nonmagnetic member 50 in addition to the similar configuration to the magnetic fluid drive device 10A of FIG. 8.

The nonmagnetic member 50 has magnetism that is not ferromagnetic, and is made of a paramagnetic material, for example. In the example of FIG. 11, two nonmagnetic members 50 are coupled to both ends of each magnetic component 51 so as to move along the ±Y side of the flow channel 20. Accordingly, the nonmagnetic member 50 can move in the flow channel 20 in conjunction with the driving of the magnetic component 51 and thus the magnet member 30.

In the magnetic fluid drive device 10B of the present modification, the magnetic fluid M1 can be stirred by the nonmagnetic member 50 even at a position far from the magnets 31 and 32 such as the ±Y sides of the flow channel 20 with avoiding shorting of the magnetic circuit by the magnet member 30. In the present modification, the nonmagnetic member 50 may not be disposed on the ±Y side of the flow channel 20, and may be coupled to the magnetic component 51 according to a desired position where the magnetic fluid M1 is to be stirred.

As described above, the magnetic fluid drive device 10B of the present modification further includes the nonmagnetic member 50 coupled to the magnetic member so as to move in the flow channel direction. According to this, the magnetic fluid M1 can be easily stirred in the flow channel 20.

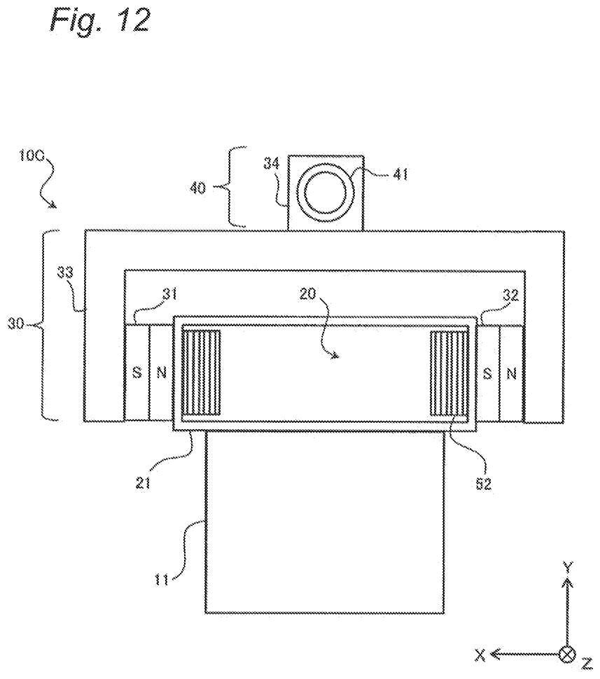

In the configuration example of FIG. 8, the magnetic component 51 is illustrated as an example of the magnetic member in the flow channel 20, but the magnetic member is not limited thereto. A modification from this viewpoint will be described with reference to FIGS. 12 to 14.

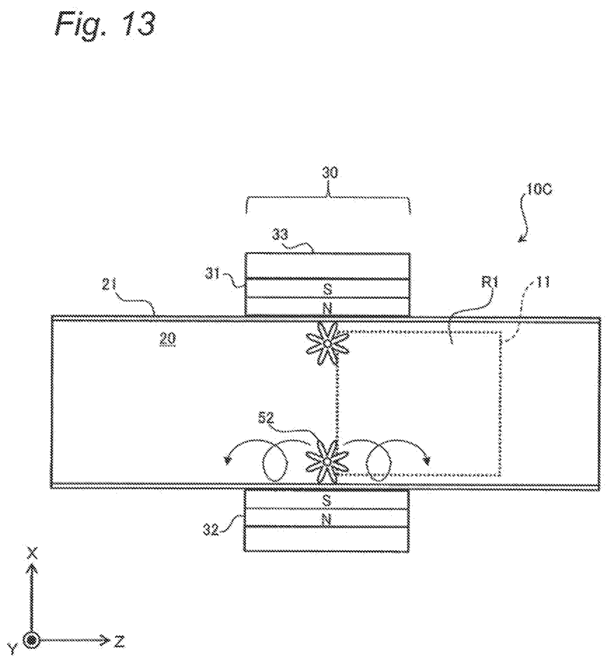

FIG. 12 is a front view of a magnetic fluid drive device 100 according to a second modification of the second embodiment. FIG. 13 is a cross-sectional view of the magnetic fluid drive device 10A with the XZ section in FIG. 12.

The magnetic fluid drive device 100 of the present modification further includes an impeller 52 in place of the magnetic component 51 in the similar configuration to the magnetic fluid drive device 10A of FIG. 8. For example, the impeller 52 has an axial direction arranged along the Y direction. The impeller 52 has a height lower than the height of the flow channel 20 by a predetermined value, for example. The predetermined value is appropriately set, such as within a range in which a dimension of the impeller 52 in a diagonal direction is larger than the height of the flow channel 20 from a viewpoint of enabling the impeller 52 to move in the flow channel 20 without falling.

According to the magnetic fluid drive device 100 of the present modification, the impeller 52 moves along the flow channel 20 with rotating in conjunction with the driving of the magnet member 30. This also makes it possible to obtain the same effect as that of the magnetic fluid drive device 10A of the second embodiment.

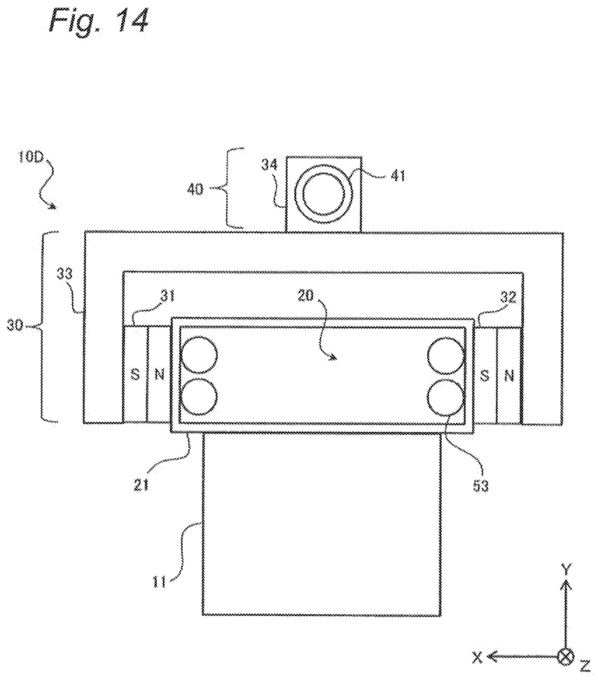

FIG. 14 is a front view of a magnetic fluid drive device 10D according to a third modification of the second embodiment. The magnetic fluid drive device 10D of the present modification includes a magnetic sphere 53 in place of the magnetic component 51 in the similar configuration to the magnetic fluid drive device 10A of FIG. 8. The magnetic sphere 53 is a sphere member made of a magnetic material. According to the magnetic fluid drive device 10D of the present modification, the magnetic sphere 53 moves along the flow channel 20 in conjunction with the driving of the magnet member 30. This also makes it possible to obtain the same effect as that of the magnetic fluid drive device 10A of the second embodiment.

As in the magnetic fluid drive devices 10A, 100, and 10D described above, the magnetic member provided in the flow channel 20 may be various members made of a magnetic material, and may be e.g. the magnetic component 51, the magnetic sphere 53, or the impeller 52. In addition, magnetic members having a plurality of types of shapes may be used together.

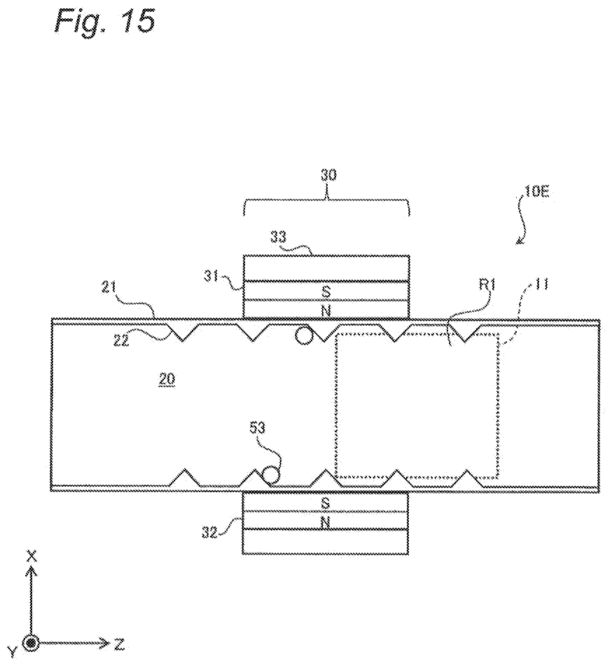

FIG. 15 is a cross-sectional view of a magnetic fluid drive device 10E according to a fourth modification of the second embodiment. For example, the magnetic fluid drive device 10E of the present modification has the similar configuration to the magnetic fluid drive device 10D of FIG. 14, with the inner wall of the flow channel 20 in the heat receiver 21 being configured by an uneven inner wall surface 22. For example, protrusions are periodically provided on the inner wall surface 22 of the flow channel 20 in the Z direction.

In the magnetic fluid drive device 10E of the present modification, by combining the uneven shape of the inner wall surface 22 and the magnetic member such as the magnetic sphere 53, various effects such as peeling-off of the sticking substance M2 by the magnetic member can be more easily obtained. The magnetic member to be combined with such inner wall surface 22 is not particularly limited to the magnetic sphere 53, and may be various magnetic members such as the impeller 52.

As described above, in the magnetic fluid drive device 10E of the present modification, the flow channel 20 has the inner wall surface 22 provided with an uneven shape in the flow channel direction. The various effects described above can be more easily obtained by movement of the various magnetic members along the uneven shape of the inner wall surface 22.

### Third Embodiment

A third embodiment will be described below with reference to the drawings. In the second embodiment, the description has been made of the magnetic fluid drive device 10A in which the magnetic member is provided in the flow channel 20. In the third embodiment, a magnetic fluid drive device in which a magnet is provided in the flow channel 20 will be described.

In the following, description of configurations and operations similar to those of the heat transport systems 1 and the magnetic fluid drive devices 10 to 10E of the first and second embodiments will be appropriately omitted, and the magnetic fluid drive device according to the present embodiment will be described.

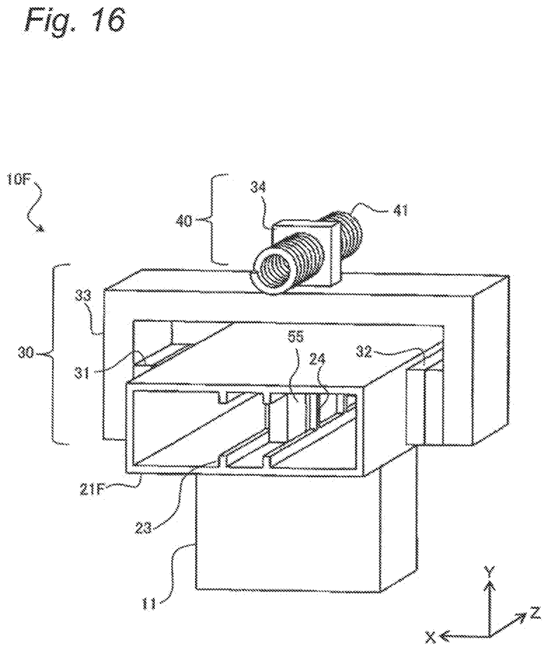

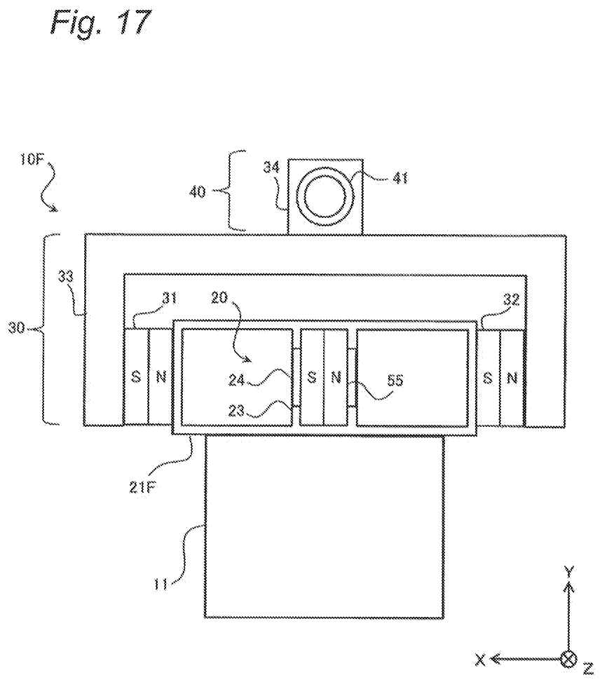

FIG. 16 is a perspective view showing a configuration example of the magnetic fluid drive device 10F according to the third embodiment. FIG. 17 shows a front view of the magnetic fluid drive device 10F of FIG. 16.

For example, the magnetic fluid drive device 10F of the present embodiment further includes an internal magnet 55 that is a magnet disposed in the flow channel 20 as shown in FIGS. 16 and 17, in addition to the similar configuration to the first embodiment. For example, as illustrated in FIG. 17, the internal magnet 55 is disposed in a direction in which the magnetic poles attract the magnets 31 and 32 of the magnet member 30. This enables the magnetic field in the flow channel 20 to be enhanced.

The heat receiver 21 in the magnetic fluid drive device 10F of the present embodiment includes a guide rail 23 provided on the inner wall of the flow channel 20 as illustrated in FIG. 16, for example. The guide rail 23 is an example of a holder that holds the internal magnet 55 so as to be slidable along the Z direction. The guide rail 23 is provided to extend in the Z direction on the inner wall on the ±Y side of the flow channel 20 so as to sandwich the internal magnet 55 from the ±X side, for example.

The guide rail 23 includes a frame 24 provided in the middle in the Z direction and extending in the Y direction. The frame 24 is disposed to contact with a principal surface of the internal magnet 55 on the ±X side. The internal magnet 55 is located at a position opposed to each of the magnets 31 and 32 in the Z direction by the action of the magnetic field by the magnet member 30.

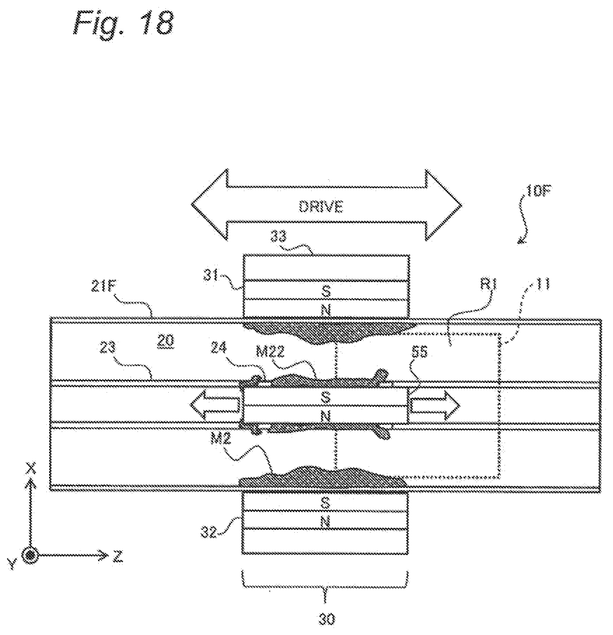

FIG. 18 is a view for explaining operation of the magnetic fluid drive device 10F of the present embodiment. In the magnetic fluid drive device 10F of the present embodiment, when the magnet member 30 outside the flow channel 20 is shift-driven by the drive mechanism 40, the internal magnet 55 moves along the guide rail 23 in the flow channel 20 following the change of the magnetic field. Such movement of the internal magnet 55 facilitates stirring of the magnetic fluid M1 or generation of a turbulence.

As an example illustrated in FIG. 18, it is conceivable that a sticking substance M22 of the magnetic fluid M1 is stuck to the internal magnet 55 of the present embodiment in the flow channel 20. To address this, in the magnetic fluid drive device 10F of the present embodiment, the sticking substance M22 can be peeled off from the internal magnet 55 according to the movement of the internal magnet 55 by the frame 24 of the guide rail 23.

As described above, the magnetic fluid drive device 10F in the present embodiment further includes the internal magnet 55 disposed inside the flow channel 20. The heat receiver 21F includes the guide rail 23 as an example of a holder that holds the internal magnet 55 such that the internal magnet 55 is movable in the flow channel direction. According to this, the internal magnet 55 can be driven in the flow channel 20 in conjunction with the shift-drive of the magnet member 30, and the same effect as that of the second embodiment can be obtained. It is also possible to facilitate driving of the magnetic fluid M1 by enhancing the magnetic field in the flow channel 20 by the magnetic field of the internal magnet 55.

In the present embodiment, the guide rail 23 includes the frame 24 provided so as to come into contact with the internal magnet 55 and extending in the Y direction intersecting the flow channel direction. The sticking substance M22 stuck to the internal magnet 55 can be peeled off as a result of contacting of the frame 24 with the sliding internal magnet 55.

### Fourth Embodiment

A fourth embodiment will be described below with reference to the drawings. In the first embodiment, the description has been made of the magnetic fluid drive device 10 that shifts the magnet member 30 along the flow channel 20. In the present embodiment, a magnetic fluid drive device for retracting the magnet member 30 from the flow channel 20 will be described.

In the following, description of configurations and operations similar to those of the heat transport systems 1 and the magnetic fluid drive devices 10 to 10F of the first to third embodiments will be appropriately omitted, and the magnetic fluid drive device according to the present embodiment will be described.

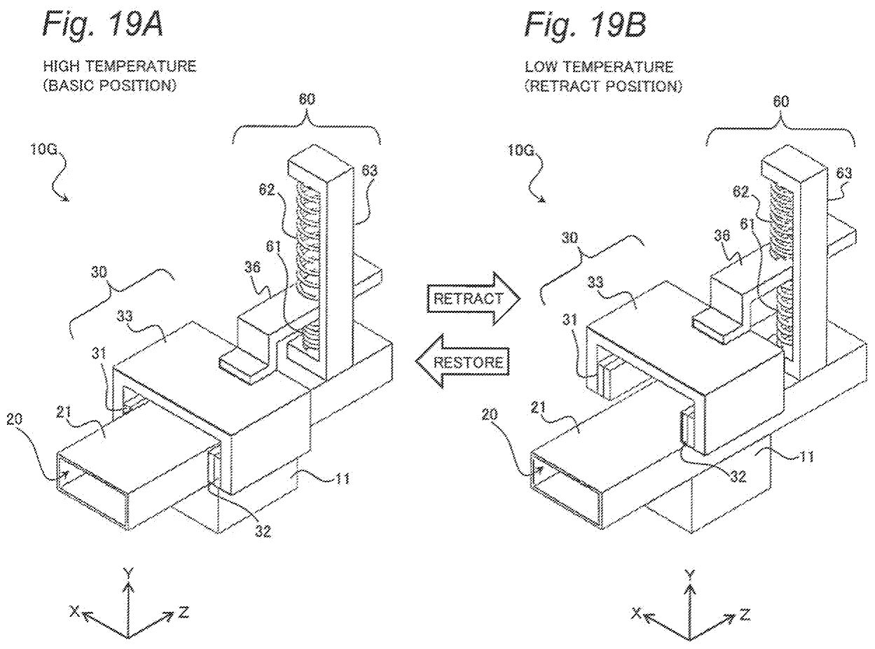

FIGS. 19A and 19B are views for explaining a configuration example of a magnetic fluid drive device 10G according to the fourth embodiment. FIG. 19A illustrates a basic position of the magnetic fluid drive device 10G at a high temperature. FIG. 19B illustrates a retraction position of the magnetic fluid drive device 10G at a low temperature.

The magnetic fluid drive device 10G of the present embodiment includes a drive mechanism 60 for retracting the magnet member 30 from the flow channel 20 in place of the drive mechanism 40 for shift-driving along the Z direction in the similar configuration to the first embodiment. In the configuration example of FIGS. 19A and 19B, the retracting drive mechanism 60 includes a coupling part 36 coupled to the magnetic yoke 33, a shape-memory member 61 provided between the coupling part 36 and the heat receiver 21, a bias spring 62, and a supporter 63 that supports the bias spring 62, for example.

The shape-memory member 61 is made of a shape-memory alloy, and holds a memorized shape that is a preset shape at the high temperature exceeding a predetermined temperature. The predetermined temperature corresponds to a transformation point of the shape-memory alloy, and is set in view of starting cooling of the heat source 11, for example. FIG. 19A illustrates the memorized shape of the shape-memory member 61. The shape-memory member 61 is disposed at a position where heat generated by the heat source 11 can be transferred. The shape-memory member 61 of the present configuration example has a spring shape. The shape-memory member 61 deforms according to an external force at the low temperature equal to or lower than the predetermined temperature as illustrated in FIG. 19B, for example.

The bias spring 62 is configured with various spring members, and is coupled to the coupling part 36 from the upward that is the +Y side opposite to the shape-memory member 61. For example, the bias spring 62 energizes the coupling part 36 so as to be pulled up toward a retraction position that is a position where the magnet member 30 is retracted from the heat receiver 21. The retraction position of the magnet member 30 is set at a position away from the flow channel 20 to such an extent that the magnetic field generated by the magnet member 30 weakly acts on the magnetic fluid M1 in the flow channel 20. For example, the retraction position is set at a position where the magnet member 30 is pulled up to such an extent that the flow channel 20 is not positioned between the magnets 31 and 32.

In the magnetic fluid drive device 10G of the present embodiment, the magnet member 30 is retracted to the retraction position away from the flow channel 20 by the retracting drive mechanism 60 at the low temperature as illustrated in FIG. 19B. This can facilitate to avoid a situation in which the magnetic fluid M1 is stuck in the flow channel 20.

At the high temperature exceeding the predetermined temperature as a result of heat generation by the heat source 11, the drive mechanism 60 of the present configuration example uses heat transferred from the heat source 11 to the shape-memory member 61 via the heat receiver 21 to restore the shape-memory member 61 to the memorized shape. According to this, in the magnetic fluid drive device 10G at the high temperature, the magnet member 30 returns to the basic position near the flow channel 20, as shown in FIG. 19A. This enables the magnetic fluid drive device 10G of the present embodiment to drive the magnetic fluid M1 at the high temperature to cool the heat source 11 as in each of the above embodiments.

As described above, in the magnetic fluid drive device 10G of the present embodiment, the retracting drive mechanism 60 moves the magnet member 30 to the retraction position (a second position) farther away from the heat receiver 21 than the basic position (the first position) in the Y direction intersecting the Z direction in which the flow channel 20 extends. This makes it easy to avoid a situation in which the sticking substance M2 is generated at the low temperature when the magnetic fluid M1 is not circulated.

In the present embodiment, for example, in a case where the temperature is higher than a predetermined temperature set for the shape-memory member 61, the retracting drive mechanism 60 moves the magnet member 30 to the basic position. In a case where the temperature is equal to or lower than the predetermined temperature, the retracting drive mechanism moves the magnet member 30 to the retraction position. In the present embodiment, such temperature control can be realized by the shape-memory member 61 in a self-excited manner.

### Modification of Fourth Embodiment

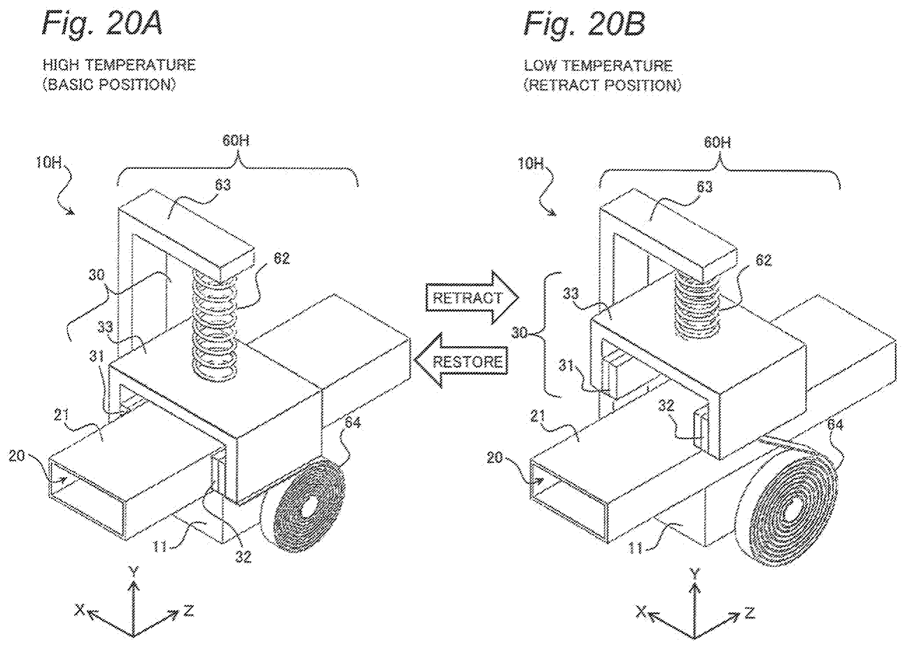

Such retracting drive mechanism 60 as in the magnetic fluid drive device 10G of the fourth embodiment described above is not limited to the configuration example shown in FIGS. 19A and 19B, and various configurations can be adopted. Modifications of the fourth embodiment will be described with reference to FIGS. 20A to 23.

FIGS. 20A and 20B are views for explaining a magnetic fluid drive device 10H according to a first modification of the fourth embodiment. FIGS. 20A and 20B illustrate a basic position of the magnetic fluid drive device 10H at a high temperature and a retraction position thereof at a low temperature, respectively.

The magnetic fluid drive device 10H of the present modification includes a retracting drive mechanism 60H using a bimetal 64 as illustrated in FIGS. 20A and 20B, in place of the drive mechanism 60 using the shape-memory member 61, in the similar configuration to FIGS. 19A and 19B. In the example of FIGS. 20A and 20B, the retracting drive mechanism 60H in the magnetic fluid drive device 10H includes the bimetal 64, the bias spring 62 coupled to the magnetic yoke 33, and the supporter 63 that supports the bias spring 62.

The bimetal 64 is formed by bonding a metal plate having a relatively higher thermal expansion coefficient and a metal plate having a lower thermal expansion coefficient, to be deformed according to a difference in the thermal expansion coefficient. In the drive mechanism 60H illustrated in FIGS. 20A and 20B, the bimetal 64 is provided to have the higher thermal expansion coefficient on an inner peripheral side in a spring shape, for example. The bimetal 64 of the drive mechanism 60H has a shape as illustrated in FIG. 20A at the high temperature, and has a shape as illustrated in FIG. 20B at the low temperature. In the present example, the bimetal 64 of the drive mechanism 60H is disposed in the vicinity of the heat source 11. According to this, the drive mechanism 60H can be easily operated in accordance with heat generated from the heat source 11.

According to the drive mechanism 60H of the present modification, the bimetal 64 is deformed according to heat transfer from the heat source 11 at the time of high heat, so that the magnet member 30 can be returned from the retraction position illustrated in FIG. 20B to the basic position in the vicinity of the flow channel 20 as illustrated in FIG. 20A. On the other hand, at the low temperature, the magnet member 30 can be retracted to the retraction position as illustrated in FIG. 20B by balancing between the bias spring 62 and the bimetal 64 with the thermal expansion being resolved.

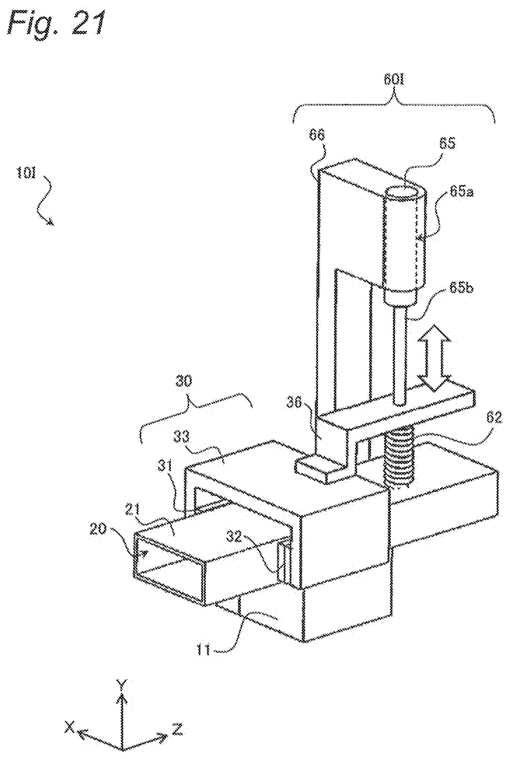

FIG. 21 illustrates a configuration of a magnetic fluid drive device 10I according to a second modification of the fourth embodiment. The magnetic fluid drive device 10I of the present modification includes, in the similar configuration to FIGS. 19A and 19B, a retracting drive mechanism 60I using a thermoelement 65 as illustrated in FIG. 21 in place of the drive mechanism 60 using the shape-memory member 61.

In the example of FIG. 21, the retracting drive mechanism 60I in the magnetic fluid drive device 10I includes the thermoelement 65, a supporter 66 of the thermoelement 65, the coupling part 36 of the magnetic yoke 33, and the bias spring 62 provided between the coupling part 36 and the heat receiver 21.

The thermoelement 65, e.g. including a thermal expansion body 65a such as paraffin and a rod-shaped piston part 65b, is a drive element that protrudes the piston part 65b using a volume change of the thermal expansion body 65a according to a temperature change. The piston part 65b of the thermoelement 65 is coupled to the coupling part 36 from the upper side opposite to the bias spring 62.

For example, the supporter 66 of the thermoelement 65 is made of a material having a relatively high heat transfer rate so that heat from the heat source 11 is easily transferred to the thermoelement 65. The supporter 66 supports, at the upward the heat receiver 21, the thermoelement 65 so as to direct the piston part 65b downward.

According to the drive mechanism 60I of the present modification, as the thermoelement 65 protrudes the piston part 65b according to heat transfer from the heat source 11 at the time of high heat, the magnet member 30 can be disposed at the basic position in the vicinity of the flow channel 20 as illustrated in FIG. 21. At the low temperature, the thermal expansion of the thermoelement 65 is eliminated, and the piston part 65b is pushed back by energizing of the bias spring 62, so that the magnet member 30 can be retracted to the retraction position.

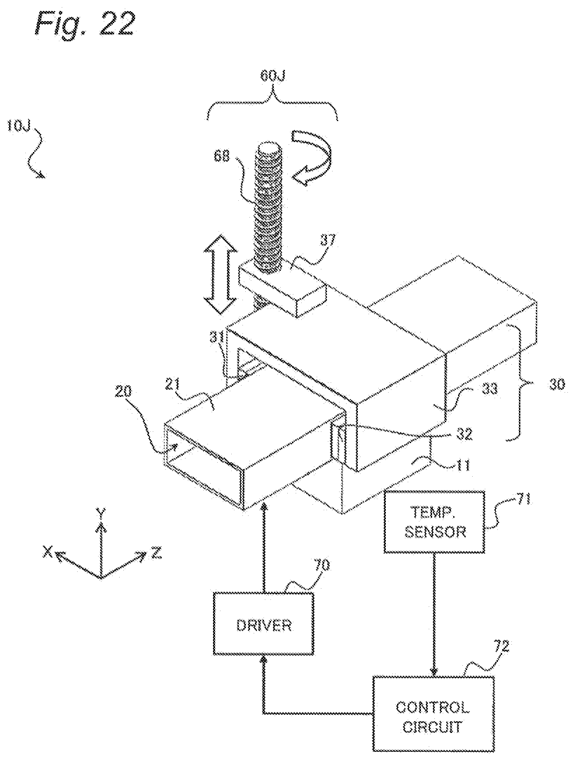

FIG. 22 is a view for explaining a magnetic fluid drive device 10J according to a third modification of the fourth embodiment. In the above, the example in which no power source is used for the drive mechanism 60 has been described. However, the present disclosure is not limited thereto, and a driver as a power source may be used.

In the modification of FIG. 22, a drive mechanism 60J of the magnetic fluid drive device 10J includes a driver 70 such as a motor or an actuator, a screw member 68 such as a rod screw or a trapezoidal screw driven by the driver 70, and a coupling part 37 fitted to the screw member 68 and coupled to the magnetic yoke 33. The driver 70 may be an external configuration of the drive mechanism 60J. For example, the screw member 68 is disposed with its longitudinal direction oriented in the Y direction.

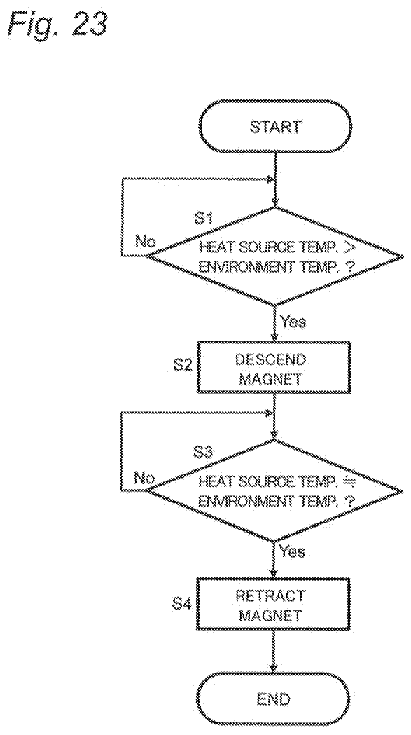

The magnetic fluid drive device 10J of the present modification may further include a temperature sensor 71 that senses temperature, and a control circuit 72 that controls the driver 70 on the basis of a sensing result of the temperature sensor 71, in addition to the configuration similar to that of the fourth embodiment. The temperature sensor 71 and the control circuit 72 may be an external configuration of the magnetic fluid drive device 10J. The temperature sensor 71 is a device for sensing the temperatures of the heat source 11 and the environment, for example. The control circuit 72 includes a CPU or an MPU, for example. FIG. 23 shows an example of processing executed by the control circuit 72 of the magnetic fluid drive device 10J.

For example, the flowchart shown in FIG. 23 is periodically and repeatedly executed by the control circuit 72 in a state where the temperature of the heat source 11 is equal to or lower than the environment temperature and the magnet member 30 is at the retraction position. The environment temperature is sequentially sensed by the temperature sensor 71, for example. Alternatively, a preset temperature may be used as the environment temperature.

First, the control circuit 72 receives input of a sensor signal indicating the temperature of the sensing result from the temperature sensor 71, and detects whether the temperature of the heat source 11 is equal to or higher than the environment temperature, based on the received sensor signal (S1). When detecting the temperature of the heat source 11 being not equal to or higher than the environment temperature (NO in S1), the control circuit 72 repeats the detection in Step S1 at an operation cycle of the temperature sensor 71, for example.

On the other hand, when detecting the temperature of the heat source 11 being equal to or higher than the environment temperature (YES in S1), the control circuit 72 controls the driver 70 so as to descend the magnet member 30 from the retraction position to the basic position (S2). This enables the magnetic fluid drive device 10J to start cooling using the magnetic fluid M1 when the heat source 11 generates heat equal to or higher than the environment temperature.

The control circuit 72 again receives input of the sensor signal from the temperature sensor 71, and detects whether the temperature of the heat source 11 reaches the environment temperature, based on the input sensor signal (S3). When detecting the temperature of the heat source 11 not reaching the environment temperature (NO in S3), the control circuit 72 repeats the detection in Step S3 at the same operation cycle as the above, for example. At this time, cooling by the magnetic fluid drive device 10J is continued until the temperature of the heat source 11 reaches the environment temperature.

As it is considered that the cooling of the heat source 11 is completed when detecting that the temperature of the heat source 11 reaches the environment temperature (YES in S3), the control circuit 72 controls the driver 70 to return the magnet member 30 to the retraction position (S4). Then, the control circuit 72 ends the processing illustrated in this flowchart, and executes the processing again at the above-described operation cycle, for example.

According to the foregoing processing, until heat generation by the heat source 11 is detected (NO in S1) and after the heat source 11 is cooled to the environment temperature (NO in S3), the driver 70 of the drive mechanism 60J is driven so as to retract the magnet member 30 in the magnetic fluid drive device 10J (S4). This enables the magnet member 30 to be accurately retracted at a time other than the time of cooling the heat source 11 by controlling a power source such as the driver 70.

### OTHER EMBODIMENTS

The first to fourth embodiments have been described in the foregoing as examples of the technique disclosed in the present application. However, the technique in the present disclosure is not limited thereto, and can also be applied to embodiments in which changes, substitutions, additions, omissions, and the like are made as appropriate. In addition, it is also possible to combine the components described in the above embodiments to form a new embodiment. Therefore, other embodiments will be exemplified below.

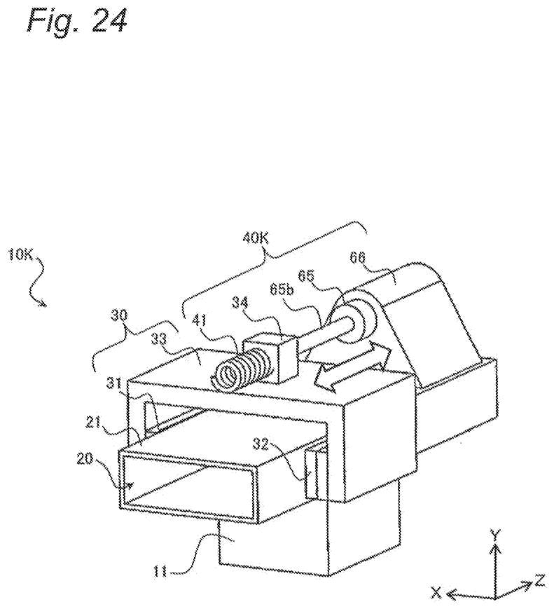

In the above-described second modification of the fourth embodiment, the description has been made of the example in which the thermoelement 65 is used for the retracting drive mechanism 60I. In the present embodiment, the thermoelement 65 may be used for the drive mechanism 40 for shifting along the flow channel direction as in the first to third embodiments. This modification will be described with reference to FIG. 24.

FIG. 24 illustrates a configuration of a magnetic fluid drive device 10K according to a first modification of the first embodiment. For example, the magnetic fluid drive device 10K of the present modification includes a drive mechanism 40K using the thermoelement 65 in the similar configuration to the first embodiment. For example, the drive mechanism 40K of the present modification includes the thermoelement 65, the supporter 66, the coupling part 34 of the magnetic yoke 33, and the drive spring 41. The thermoelement 65 is disposed with the piston part 65b facing the Z direction. Further, the piston part 65b is coupled to the coupling part 34 from the side opposite to the drive spring 41. According to such drive mechanism 40K, the magnet member 30 can be shift-driven along the flow channel 20 according to a temperature change by the heat source 11 or the like.

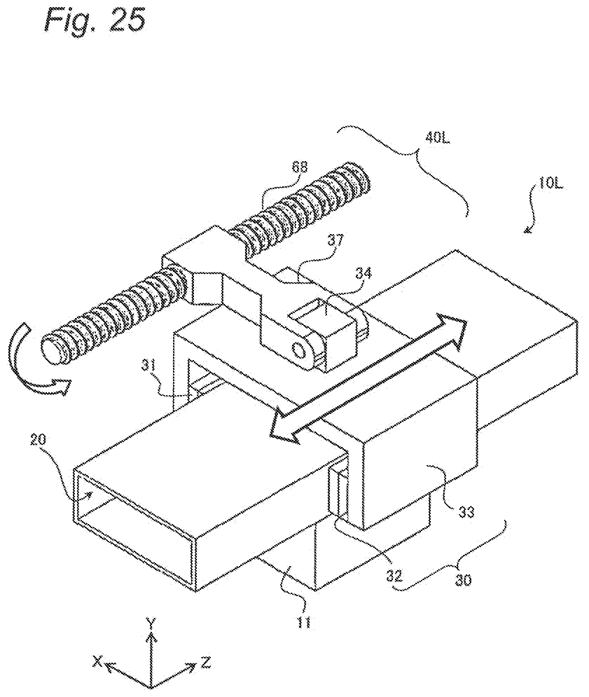

In the above-described third modification of the fourth embodiment, the description has been made of the example in which the driver 70 constituting the power source is used for the retracting drive mechanism 60J. In the present embodiment, the driver 70 may be used for the drive mechanism 40 for shifting as in the first to third embodiments. This modification will be described with reference to FIG. 25.

FIG. 25 illustrates a configuration of a magnetic fluid drive device 10L according to a second modification of the first embodiment. In the magnetic fluid drive device 10L of the present modification, similarly to the modification shown in FIG. 22, a drive mechanism 40L is driven by the driver 70 (not illustrated) in the similar configuration to the first embodiment. For example, the drive mechanism 40L of the present modification, in which the screw member 68 is arranged in the I direction along the flow channel 20, shift-drives the magnet member 30 in the Z direction. In the magnetic fluid drive device 10L of the present modification, the temperature sensor 71 and the control circuit 72 may be used as in the above modification.

In the above embodiments, the description has been made of the example in which the magnet member 30 includes the two magnets 31 and 32 and the magnetic yoke 33, but the configuration of the magnet member is not particularly limited thereto. In the present embodiment, the magnet member may include three or more magnets, or may be one magnet. In the present embodiment, the magnet member may not include the magnetic yoke. Also in such a magnet member, by shifting the magnetic pole that generates a magnetic field acting on the magnetic fluid M1 along the flow channel 20 or by retracting the magnetic pole from the flow channel 20 by the drive mechanism of each of the above embodiments, the same effect as described above can be obtained.

In the above embodiments, the permanent magnet is exemplified as the magnet included in the magnetic fluid drive device 10. In the present embodiment, the magnet in the magnetic member of the magnetic fluid drive device 10 is not necessarily a permanent magnet, and may be an electromagnet, for example.

In the above embodiments, the description has been made of the example in which the heat source 11 is a planar heat source having a heat generation surface, but the heat transport system 1 of the present embodiment is not particularly limited thereto. The heat transport system 1 may use the magnetic fluid drive device 10 when cooling a heat source that is not a planar heat source.

In the above embodiments, the description has been made of the example in which the magnetic fluid drive device 10 constitutes the cooling mechanism of the heat source 11 in the heat transport system 1, but the applications of the heat transport system 1 and the magnetic fluid drive device 10 are not particularly limited to the cooling mechanism. The heat transport system 1 is allowed to use the magnetic fluid drive device 10 for the purpose of transferring various kinds of heat. For example, the magnetic fluid drive device 10 may be applied for heating a lithium ion battery or the like when an environment temperature is low. In this case, the battery to be heated is disposed at the same position as the radiator 12 in the heat transport system 1 described above.

As described in the foregoing, the embodiments have been described as examples of the technique in the present disclosure. For this purpose, the accompanying drawings and the detailed description have been provided.

Accordingly, the components described in the accompanying drawings and the detailed description may include not only components essential for solving the problem but also components that are not essential for solving the problem in order to illustrate the above technique. Therefore, it should not be immediately recognized that these non-essential components are essential on the basis of the fact that these non-essential components are described in the accompanying drawings and the detailed description.

The present disclosure is applicable to cooling of components in various electronic apparatuses, for example, and is applicable to apparatuses that generate heat by light output, such as a projector. The present disclosure is applicable also to various fields such onboard apparatuses as headlights and lithium ion batteries, and information apparatuses such as a PC and a smartphone.

1. A magnetic fluid drive device for driving a magnetic fluid having temperature sensitivity in accordance with heat reception,
the magnetic fluid drive device comprising:
a heat receiver having a flow channel through which the magnetic fluid flows, to receive heat;
a magnet member disposed outside the flow channel to generate a magnetic field; and
a drive mechanism that changes a position of the magnet member with respect to the heat receiver from a first position that is adjacent to the heat receiver with the magnet member applying the magnetic field to the magnetic fluid in the flow channel.

2. The magnetic fluid drive device according to claim 1, wherein the drive mechanism changes the position of the magnet member with respect to the heat receiver in a flow channel direction in which the flow channel extends.

3. The magnetic fluid drive device according to claim 2, further comprising:
a magnetic member disposed inside the flow channel in the heat receiver to move according to a change in the position of the magnet member in the flow channel direction.

4. The magnetic fluid drive device according to claim 3, further comprising
a nonmagnetic member coupled to the magnetic member to move in the flow channel direction.

5. The magnetic fluid drive device according to claim 3, wherein the magnetic member includes at least one of a sphere, a slider, or an impeller, each made of a magnetic material.

6. The magnetic fluid drive device according to claim 3, wherein the flow channel has an inner wall surface provided with an uneven shape in the flow channel direction.

7. The magnetic fluid drive device according to claim 2, further comprising:
a magnet disposed inside the flow channel, wherein
the heat receiver includes a holder that holds the magnet to be movable in the flow channel direction.

8. The magnetic fluid drive device according to claim 7, wherein the holder includes a frame contactable with the magnet and extending in a direction intersecting the flow channel direction.

9. The magnetic fluid drive device according to claim 1, wherein
the drive mechanism moves the magnet member to a second position that is farther away from the flow channel than the first position in a direction intersecting with a flow channel direction in which the flow channel extends, the second position weakening the magnetic field by the magnet member acting on the magnetic fluid.

10. The magnetic fluid drive device according to claim 9, wherein
the drive mechanism includes a thermal expansion body, and a supporter that supports the thermal expansion body to transfer, onto the thermal expansion body, heat from a heat source subject to the heat reception by the heat receiver, and
the drive mechanism
moves the magnet member to the first position in a case where a temperature of the thermal expansion body is higher than a predetermined temperature, and
moves the magnet member to the second position in a case where the temperature of the thermal expansion body is equal to or lower than the predetermined temperature.

11. The magnetic fluid drive device according to claim 9, comprising:
a temperature sensor that senses a temperature of a heat source subject to the heat reception by the heat receiver, and an environment temperature; and
a control circuit that controls the drive mechanism, based on a sensing result of the temperature sensor, wherein
the control circuit causes the drive mechanism to:
move the magnet member to the first position in a case where the temperature of the heat source is higher than the environment temperature, and
move the magnet member to the second position in a case where the temperature of the heat source is equal to or lower than the environment temperature.

12. The magnetic fluid drive device according to claim 9, wherein
the drive mechanism includes a predetermined member that deforms into a predetermined shape according to the heat reception exceeding a predetermined temperature, and
the drive mechanism
moves the magnet member to the first position in a case where a temperature of the predetermined member is higher than the predetermined temperature, and
moves the magnet member to the second position in a case where the temperature of the predetermined member is equal to or lower than the predetermined temperature.

13. The magnetic fluid drive device according to claim 9, wherein the direction intersecting the flow channel direction is orthogonal to the flow channel direction.

14. The magnetic fluid drive device according to claim 2, wherein
the drive mechanism changes the position of the magnet member in the flow channel direction to stir the magnetic fluid by the magnetic field generated by the magnet member.

15. A heat transport system comprising:
the magnetic fluid drive device according to claim 1; and
a radiator coupled to the magnetic fluid drive device, to dissipate heat from the magnetic fluid.
